(19) United States
(12) Patent Application Publication
(10) Pub. No.: US 2010/0091909 A1
(43) Pub. Date: Apr. 15, 2010

(54) SYSTEMS AND METHODS FOR UNEQUAL ERROR PROTECTION AND SOFT DECISION CALCULATIONS

(75) Inventors: Daniel Wayne Ericson, Hollis, NH (US); Jun Ni, Liberty Lake, WA (US); Liang Ban, Burlington, MA (US)

Correspondence Address: HARRIS CORPORATION;C/O DARBY & DARBY PC, P.O. BOX 770, CHURCH STREET STATION, NEW YORK, NY, 10008-0770, US

(73) Assignee: Harris Corporation, Melbourne, FL (US)

(21) Appl. No.: 12/574,987

(22) Filed: Oct. 7, 2009

Related U.S. Application Data
(60) Provisional application No. 61/104,598, filed on Oct. 10, 2008.

(51) Int. Cl. H04L 27/06; H04L 27/22

(52) U.S. Cl. 375/329; 375/340; 375/341

(57) ABSTRACT

A wireless communications device (200) is provided. The device includes a demodulator (210) configured for computing estimated bits for a modulated input signal 220 representing a the symbols associated with a frame, the estimated bits including estimated values for a frame of bits and at least one forward error correction (FEC) error bit encoded into the symbols. The device further includes an FEC decision decoder (212) configured for receiving at least a first portion of the estimated bits and calculating values for a first portion of the frame bits associated with the first portion of said the estimated bits, where the estimated bits are computed based on a condition of a communication channel associated with the modulated input signal and a frequency deviation associated with said demodulator.

### CROSS REFERENCE TO RELATED APPLICATIONS

This application claims the benefit of Provisional Application Ser. No. 61/104,598 entitled “SYSTEMS AND METHODS FOR UNEQUAL ERROR PROTECTION AND SOFT DECISION CALCULATIONS”, filed Oct. 10, 2008, which is herein incorporated by reference in its entirety.

### FIELD OF THE INVENTION

This invention relates generally to wireless communication systems, and more particularly, to methods for error correction in wireless communication systems.

### BACKGROUND OF THE INVENTION

Wireless communication systems are increasingly required to handle greater amounts of voice and data traffic. This increasing capacity requirement has resulted in a need for higher spectral efficiency, i.e., the amount of information that can be transmitted over a given bandwidth in a digital communication system. In general, the spectral efficiency is a measure of the efficiency of the use of a frequency spectrum by a physical layer protocol. Accordingly, the spectral efficiency is the channel capacity or maximum throughput of a communication link when a particular communication method is used, for example, when a particular modulation scheme is used.

In response to this need for higher spectral efficiency, higher order modulation schemes, as well as improved channel coding techniques have been developed. In digital communications, a digital signal is typically modulated onto a carrier frequency using, for example, a Phase-shift keying (PSK), Frequency-shift keying (FSK), or Quadrature amplitude modulation (QAM) schemes. Additionally, Forward error correction (FEC) coding (i.e., FEC encoding and/or decoding) is also typically employed with modulation schemes to protect the communication of the digital data or voice encoded into a transmitted signal from signal errors.

In general, a soft-decision FEC decoder, which decodes bits in a signal based on symbol decisions and some measure of the quality of each symbol decision, provides increased decoding accuracy as compared to a hard-decision FEC decoder that uses only the symbol decisions. One type of soft-decision decoder is a soft-input-hard-output decoder, which receives a soft-decision input, as described above, from a demodulator and provides a hard-decision output. Two examples of these types of decoders are a soft-decision Golay decoder and a soft-decision Viterbi decoder. Another type of soft-decision decoder is a soft-input-soft-output decoder, which receives a soft-decision input from a demodulator and provides a soft decision output (i.e., the bits and a measure of quality of each bit decision). However, it is typically difficult to calculate soft-decisions in FSK or more generally CPM (continous phase modulation) schemes. In particular, the soft-decision output from the demodulator in a soft-input-soft-output decoder scheme is typically a log-likelihood ratio (LLR) value and direct calculations of LLR values are generally complex. Log likelihood ratio is a log function of a maximum likelihood decoder (MLD), which is used to calculate the most likely codeword (data) transmitted.

### BRIEF DESCRIPTION OF THE INVENTION

Embodiments of the inventions concern systems and methods for error correction in wireless communication systems. In a first embodiment of the invention, a wireless communications device is provided. The device includes a demodulator configured for computing a plurality of estimated bits for a modulated input signal representing a plurality of symbols associated with a frame, where the plurality of estimated bits includes estimated values for a plurality of frame bits and at least one forward error correction (FEC) error bit encoded into the plurality of symbols. The device also includes at least one FEC decision decoder configured for receiving at least a first portion of the plurality of estimated bits and calculating values for a first portion of the plurality of frame bits associated with the first portion of the plurality of estimated bits. In the device, the plurality of estimated bits are computed based on a condition of a communication channel associated with the modulated input signal and a frequency deviation (L) associated with the demodulator.

In a second embodiment of the invention, a method for operating a wireless communications device in a wireless communications network is provided. The method includes the step of demodulating a modulated input signal received over a communication channel, where the modulated input signal includes a plurality of symbols associated with a frame. The method also includes the step of computing a plurality of estimated bits from the modulated input signal, the plurality of estimated bits includes estimated values for a plurality of frame bits and at least one forward error correction (FEC) error bit encoded into the plurality of symbols. The method further includes the step of calculating values for at least a first portion of the plurality of frame bits associated with the first portion of the plurality of estimated bits. In the method, the plurality of estimated bits are computed based on a condition of the communication channel and a frequency deviation (L) associated with the demodulating.

In a third embodiment of the invention, a method of performing soft decision calculations in a multi-level continuous phase modulation (CPM) system is provided. The method includes the steps of determining phase and amplitude information for a signal, and performing the soft decision calculations using the determined phase and amplitude information.

### BRIEF DESCRIPTION OF THE DRAWINGS

FIG. 1 shows a wireless communications system in which an embodiment of the present invention can be practiced.

FIG. 2 is a block diagram of a portion a communications device configured in accordance with an embodiment of the invention.

FIG. 3 is a block diagram of the alternate transmit path configuration for the transmit path in FIG. 2 in accordance with an embodiment of the invention.

FIG. 4 is a block diagram of the alternate receive path configuration for the receive path in FIG. 2 in accordance with an embodiment of the invention.

FIG. 5 is a log plot of block error rate versus Es/No (the energy per bit to noise power spectral density ratio) for Turbo codes and Reed-Solomon codes on a Gaussian channel.

FIG. 6 is a log plot of block error rate versus Es/No (the energy per bit to noise power spectral density ratio) for Turbo codes and Reed-Solomon codes on a Fading channel.

FIG. 7 is provided a block diagram of a computing device which can be configured for performing one or more methods described above in accordance with an embodiment of the invention.

### DETAILED DESCRIPTION OF THE INVENTION

The present invention is described with reference to the attached figures, wherein like reference numerals are used throughout the figures to designate similar or equivalent elements. The figures are not drawn to scale and they are provided merely to illustrate the invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

As described above, the use of soft-decision FEC decoders for CPM schemes has generally been limited by the inherent complexity in the calculation of LLR values. Additionally, the addition of error bits to a frame increases the overall bit rate, a higher received power level is generally required in order to be able to receive the signal. Therefore, a higher transmission power or greater receiver sensitivity is generally required. One conventional approach has been to provide a hardware-based solution that increases the computation power, transmission power, and sensitivity. Such a hardware-based approach can provide a measurable performance enhancement, but the replacement and/or upgrade costs for an already deployed communications system are typically cost prohibitive. Conventional software-based approaches have examined computation involved in the soft-decision process, but have generally been developed for purposes of improving data traffic capacity in conventional cellular telephony systems. As a result, such approaches often address capacity issues in a network, and fail to address computational efficiency or sensitivity issues. Consequently, such methods are generally unsuitable for enhancing performance in noise limited systems, such as public safety systems.

To overcome the limitations of conventional solutions, the various embodiments of the invention provide an FEC coding system and method that results in significantly enhanced. performance in noise limited environments. In particular, embodiments of the invention provide a software-based solution for implementing an FEC decoding scheme with increased computational efficiency, with respect to LLR value computation, in wireless systems using multi-level CPM schemes. Additionally, the various embodiments of the invention are combined with one or more techniques for reducing computation requirements or implementing techniques that improve performance significantly.

Although the various embodiments of the invention are described below with respect to an exemplary wireless communication system, this is for illustrative purposes only. Variations in the arrangement and type of the components can be made without departing from the spirit or scope of the invention. For example, a wireless communications system in accordance with an embodiment of the invention can be configured to include more or less components than shown in the exemplary embodiments described below.

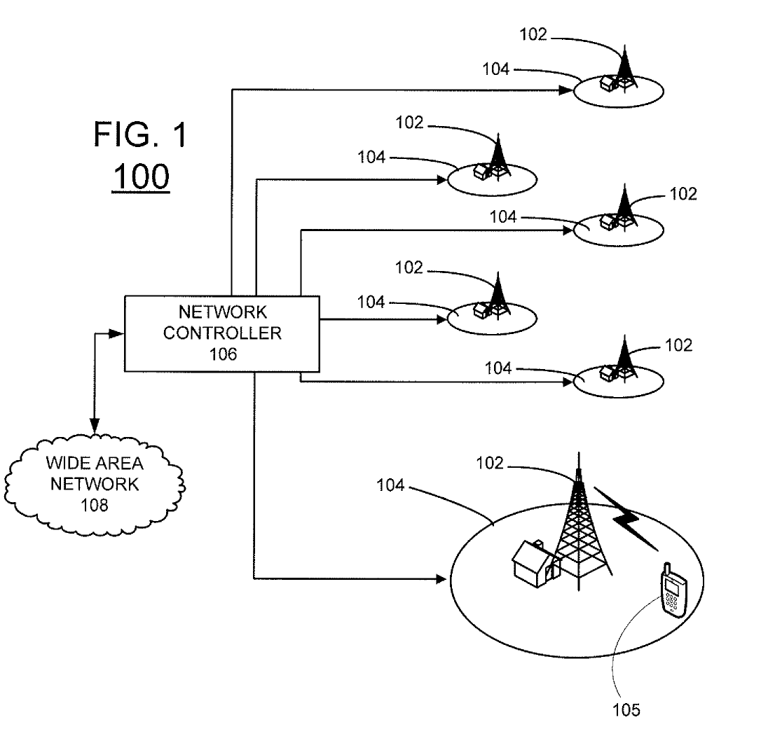

FIG. 1 shows a wireless communications system 100 in which an embodiment of the present invention can be practiced. As shown in FIG. 1, system 100 includes a plurality of access points or base stations 102 covering one or more corresponding communication cells or areas 104. Therefore, each of base stations 102 can communicate with any compatible communications devices, such as device 105, in a one of corresponding areas 104. Systems and methods for providing and operating base stations in various types of wireless communication systems are well known to one of ordinary skill in the art and therefore will not be described in great detail herein. For example, the base stations 102 in FIG. 1 can be configured to operate similar to the base stations (i.e., cell towers) in a cellular network system, including transmitting and receiving radio frequency (RF) signals and other air interface functions. However, the invention is not limited in this regard and the various embodiments of the invention can be used with any wireless communications system utilizing a multi-level CPM scheme.

The plurality of base stations 102 are connected to a network controller 106. In the embodiment illustrated in FIG. 1, the controller 106 is configured to provide mobility management for devices moving among areas 104. For a widely deployed wireless communications system, one or more controllers 106 are connected through, for example, a Wide Area Network (WAN) 108. In FIG. 1, all of the connections to WAN 108, including the connection between the base stations 102 and the controller 106 and the connection between different controllers 106 are established over private network connections, public networks, or any combination thereof. For example, in one embodiment of the invention, the connections are configured to exchange information using public or private Internet Protocol (TCP/IP) connections. However, the various embodiments of the invention are not limited in this regard and any other type or combination of network connections can be used.

The wireless communication system 100 in FIG. 1 can implement a channel access method to allow multiple communications devices in each of areas 104 to connect simultaneously to a corresponding one of base stations 102. For example, the system in FIG. 1 can be implemented using time division multiple access (TDMA) technology. However, in system 100 and in the various embodiments of the invention, any other channel access methods can be used, including, but not limited to frequency division multiple Access (FDMA), code division multiple access (CDMA), space-division multiple access (SDMA), polarization division multiple access (PDMA), pulse-address multiple access (PAMA), and any variants thereof.

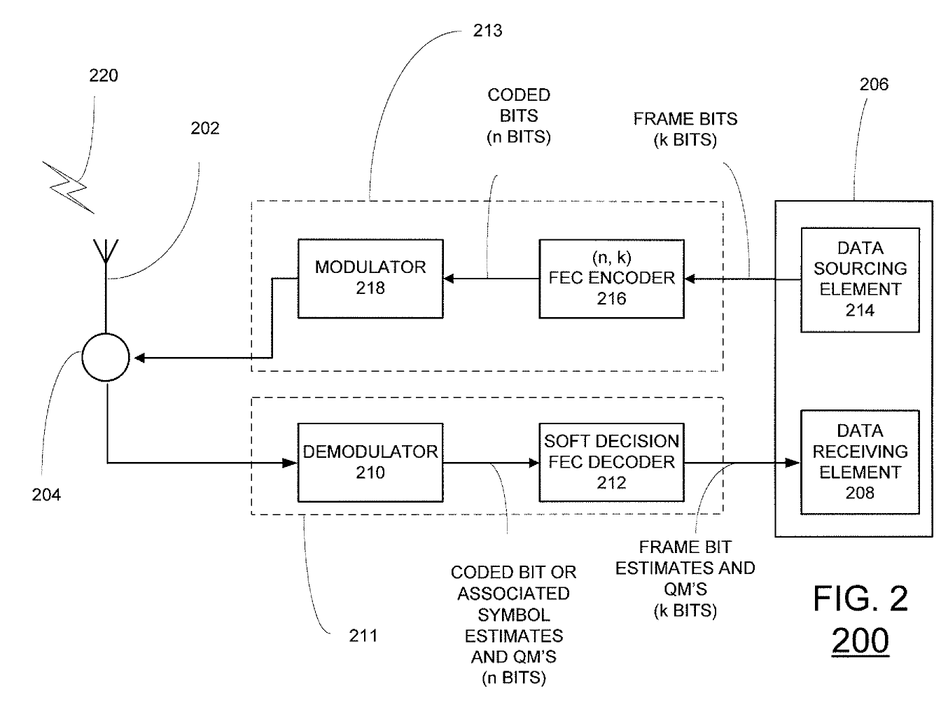

As described above, one aspect of the invention is implementing improved efficiency FEC decoding techniques in communications devices operating in a communications system, such as for devices operating in system 100. This is described below with respect to FIG. 2.

FIG. 2 is a block diagram of a portion of a communications device 200, such as base station 102 or device 105 in FIG. 1, configured in accordance with an embodiment of the invention. As shown in FIG. 2, device 200 includes an antenna 202, RF transceiver elements 204, and a controller 206. In device 200, controller 206 can be configured to control the operation of the various components in device 200. Such control can be provided based on user input, internally generated instructions, or instructions received from another wireless device, such as base station 102

Along a receive path 211 between RF transceiver elements 204 and a data receiving element 208 of controller 206, device 200 includes a demodulator 210 and a soft-decision FEC decoder 212, where the output of the demodulator 202 is coupled to the input of FEC decoder 204. Along a transmit path 213 between a data sourcing element 214 of controller 206 and RF transceiver elements 204, device 200 includes an FEC encoder 216 and a modulator 218, where the output of the FEC encoder 216 is coupled to the input of modulator 218. Systems and methods for operating a RF transceiver element with transmit and receive paths are well known to one of ordinary skill in the art and therefore will not be described herein.

In a transmit operation, FEC encoder 216 receives a sequence of frame bits (e.g., k bits) from data sourcing element 214. These k bits can represent digital information or voice bits in a data frame. As shown in FIG. 2, FEC encoder 216 is an (n, k) FEC encoder. That is, for k input bits, FEC encoder 216 generates a sequence of n coded bits (i.e., k information bits+n-k error bits). Accordingly, FEC encoder 216 outputs the n coded bits to the modulator 218. The modulator 218 then generates a modulated output signal for RF elements 204, representing the n coded bits. In some embodiments, modulator 218 can generate symbols based on the n coded bits and the symbols can be used to modulate a carrier. In other embodiments, the n coded bits can be used to directly modulate the carrier. Based on the modulated output signal, the RF elements 204 then transmit a signal 220 via antenna 202. Systems and methods for transmitting signals generated by a modulator are well known to one of ordinary skill in the art and therefore will not be described herein.

In a receive operation, antenna 202 receives signal 220. The signal 220 is communicated by RF transceiver elements 204 as a modulated signal representing the frame bits of one or more data frames, to demodulator 210. The demodulator 210 then performs channel measurements to obtain estimates and quality measures (QM's) of the transmitted n coded bits of a data frame. In embodiments where signal 220 was modulated using symbols derived from the n coded bits, the demodulator can be configured to provide estimates and QM's of the symbols. The demodulator 210 then forwards these estimates to the FEC decoder 212. The FEC decoder 212 utilizes these estimates, along with knowledge of how the n coded bits (and the symbols, if applicable) were created at the transmitting wireless device, to generate estimates of the k frame bits. The decoder 212 then detects and corrects errors in the n coded bit estimates and recovers the original k frame bits. These recovered k frame bits are then communicated to the data receiving element 206 for further processing by control 206.

Although a wireless communications device, such as that shown in FIG. 2, can be implemented using any type of FEC coding scheme, the overall computational efficiency of such conventional FEC coding schemes is generally limited. As described above, conventional soft-decision FEC calculations are typically complex in nature and therefore tend to be computationally intensive. In particular, the direct calculation of the log likelihood ratio (LLR) for each symbol in a multi-level CPM scheme is generally nontrivial, but is required to successfully perform FEC soft-decision decoding. LLR typically requires calculating the ratio of probability density functions of the matched filter output when the matched filter is associated with the symbol transmitted and when the matched filter is not associated with the symbol transmitted. In general, the complexity of the calculation of these probability density functions for a particular signal requires consideration of the modulation/demodulation techniques being used. As a result, the calculation can become extremely complex for modulation/demodulation techniques based on FSK, PSK, or QAM.

Therefore, the various embodiments of the invention provide a method for efficient computation of LLR values for FEC soft-decision decoding operations at the demodulator 210. In particular, the LLR values of the symbols in the multi-level CPM signal are calculated by the multiplication of two factors instead of using a conventional direct calculation technique. This is set forth in Equation 1, shown below:

LLR=SNR×L^{α}, (1)

where SNR is the signal to noise ratio of the symbol and the L^{α} is the frequency deviation, wherein α is the weighting factor. Thus, the soft-decision is calculated based on both amplitude and phase information, namely the SNR (signal energy) and the frequency deviation (L), respectively.

The forms of LLR shown in Equation 1 is obtained as follows. Typically, for a symbol by symbol demodulator operating with a set of equal power symbols, such as would be expected in FSK signaling, the LLR can typically be simplified to:

LLR(m)=log(I₀(Axₘ/σ²)) (2)

where I₀ is the modified Bessel function, A is the amplitude of the signal, xₘ is the envelope of the matched filter, and σ² is the noise variance. In the various embodiments of the invention, it is assumed that values for x are small, therefore log(I₀₍ₓ₎)˜0.25x². Using this approximation, LLR(m) can be reduced the form in Equation 1 as shown below:

LLR(m)˜A²xₘ²/σ⁴˜(SNR)²*xₘ²/A²˜(SNR*L)², (3)

since A⁴/σ⁴˜SNR² and xₘ²/A²˜L². This approximation has been found to be accurate for small values of Axₘ/σ². Furthermore, it has been found to be sufficient for most communications since for very small values of Axₘ/σ², demodulator performance is too poor for reliable communications anyways. With respect to large values of Axₘ/σ², the demodulation will generally be error free and thus FEC is irrelevant. Consequently, any errors in the approximation provided in Equation 1 for very small and large values of Axₘ/σ² are generally not important and it can be therefore applied for all values of Axₘ/σ². Although Equation 3 shows that the weighting factor α is equal to 2, the weighting factor shifts the ranges over which values of the argument are significant. This range may be dependent on the specific mix of demodulator and FEC scheme.

In some embodiments of the invention, α can be a fixed value, as shown above in Equation 3. In such embodiments, the value for α can be determined experimentally or analytically for a particular communications system. For example, α value at or near 1 has been found to be a good approximation of LLR for a particular wireless communication system using Gaussian shift-keying techniques In other embodiments of the invention, α can be vary. For example, in some embodiments, α can be set dynamically as a function of the estimated SNR of the signal

In the various embodiments of the invention, the value for L can be calculated according to the output of demodulator 210. In particular, the output frequency of the demodulator can be used to determine a value for L or the value of L may be fixed (known) to the receiver. With respect to the value for SNR, the value can be computed directly or estimated. For example, in some embodiments, SNR can be approximated as the average energy of the received symbol. In particular, a system operating with a static noise level can measure signal strength and calculate SNR by dividing the current estimate of the signal power by the noise level. For dynamic noise environments other methods may be used to estimate the noise power including but not limited to: measuring noise power during idle periods in the signal and measuring signal and noise power during active periods or alternatively measuring the average error associated with hard decisions in the demodulator.

A second aspect of the invention is to use alternate FEC encoding and decoding algorithms to improve performance by improving computational efficiency and/or improving sensitivity (via coding gain). In particular, the various embodiments of the invention combine use of the computation of LLR in Equation 1 with bit prioritization techniques and/or high encoding rate FEC algorithms to improve computational efficiency and/or improve receiver performance.

Bit prioritization is based on the fact that protection of all of the bits in a stream of data frames is not necessary or that at least the same level of protection is not necessary for all the bits in each data frame. One example of such a stream is a digital voice stream, such as 4-slot wireless voice communication system that uses a 2400 bit per second (bps) Advanced Multi-Band Excitation (AMBE) vocoding. In such digital voice streams, each frame contains 48 bits and can generate 20 milliseconds (ms) of voice. However, rather than protecting all 48 bits, computation efficiency can be improved by selectively protecting only the most important bits of the voice frame. In particular, the bits most significantly affecting voice quality. In the case of the 48 AMBE bits, the bits protected by FEC coding could be:

6 bits for pitch value and frame type;

5 bits for gain;

4 bits for voice/un voice decision; and

Top 9 bits of the band magnitude data.

However, the various embodiments of the invention are not limited in this regard and the number of protected bits can vary.

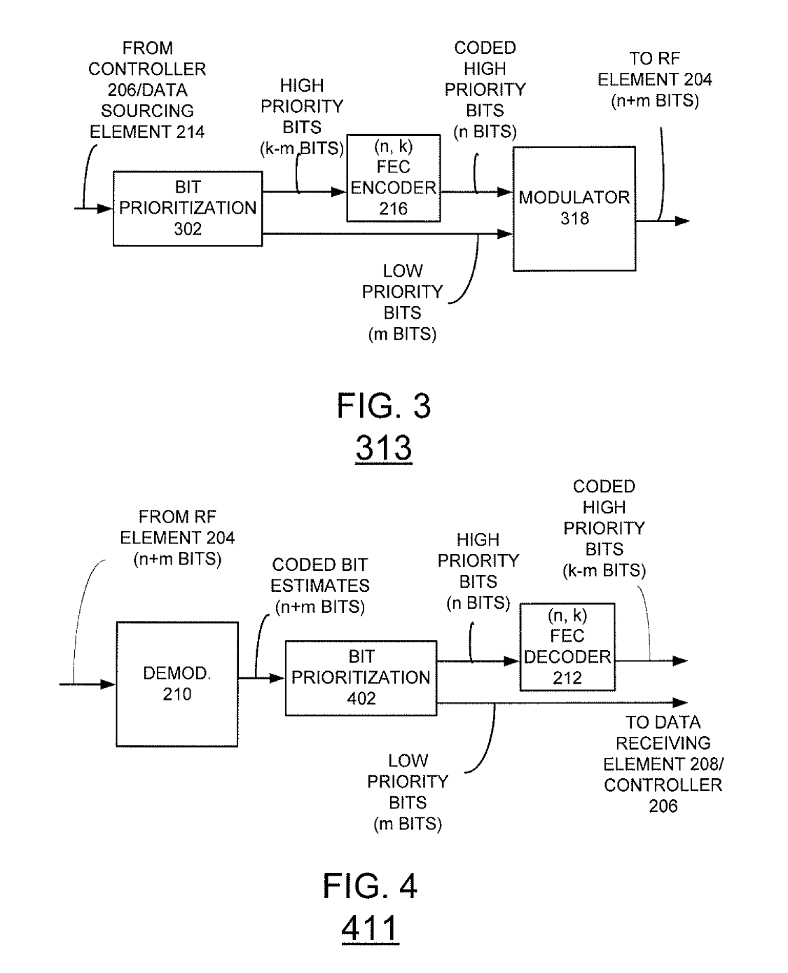

Therefore, in the various embodiments of the invention, bits can be prioritized for FEC encoding. For example, in a digital voice stream, voice bits can be prioritized into two levels, where only the high priority bits are protected, as described below with respect to FIGS. 3 and 4.

FIG. 3 is a block diagram of the alternate transmit 313 for transmit path 213 in FIG. 2 in accordance with an embodiment of the invention. As shown in FIG. 3, the transmit path 313 is modified in several ways. First, the k frame bits from data sourcing element 214 are not directly communicated to FEC encoder 216. Rather, the k bits are first communicated to a bit prioritization element 302 that divides the k bits into at least two streams of bits. For example, as shown in FIG. 3, the k bits are divided into a stream of m low priority bits and a stream of k-m high priority bits. The stream of k-m high priority bits are FEC encoded to produce a stream and recombined with the stream of m bits at modulator 318 to produce the output signal for RF element 204.

On a receiving end, a corresponding receive path architecture can be provided. FIG. 4 is a block diagram of the alternate transmit path 411 for transmit path 211 in FIG. 2 in accordance with an embodiment of the invention. As shown in FIG. 4, the transmit path 411 is modified in several ways. First, the n+m coded bit estimates and QM's from demodulator 210 are not directly communicated to FEC decoder 212. Rather, the n+m estimates and QM's are first communicated to a bit prioritization element 402 that divides the n+m bits into at least two streams of bits. For example, as shown in FIG. 4, the n+m bits are divided into a stream of m low priority bits and a stream of n high priority bits. The stream of n high priority bits are FEC decoded at decoder 212 to produce a stream of k-m bits. The k-m bits can then be recombined with the m bits at controller 206 or using some other component. Alternatively, the demodulation can provide symbol estimates and QM's, as described above. However, the operation using symbols is effectively the same.

In the various embodiments of the invention, the bit priority for encoding the various bits in a frame can be selected in a variety of ways. For example, the known structure of an AMBE vocoder voice frame can be used to select the bits most significantly affecting voice quality, as described above. However, the various embodiments of the invention are not limited to prioritization of bits in voice frames. Rather, the various embodiments of the invention can be used to provide FEC coding for any type of frame in which errors in at least a portion of the bits do not need to be error-free. Accordingly, in some embodiments of the invention, bit prioritization can generate two or more groups of bits, where the amount of error bits associated with each group of bit is selected based on an amount of redundancy needed. In general, as the number of FEC bits is increased for a group of bits, the greater the amount of redundancy.

As a result of the unequal error protection in the voice frame, an improvement is computational efficiency is observed due to the reduced complexity in computing FEC error bits for smaller numbers of frame bits. Furthermore, an increase of redundancy for critical bits is provided, as the error bits are based on a fewer number of frame bits. For example, in the case of a 48 bit AMBE vocoder voice frame with 24 critical bits, as described above and 12 FEC error bits, each error bit is associated with error correction for 2 critical bits. In contrast, if the 12 error bits are computed based on all 48 bits, each error bit is associated with 4 critical bits. Accordingly, bit prioritization can result in the redundancy for the 24 critical bits being significantly improved. As a result of the reduced number of bits needed to be coded, this provides an improvement in receiver sensitivity, which in case described above can be at least 1.5 dB. Furthermore, since the number of bits to be FEC coded is reduced, an FEC coding algorithm can be selected which is more efficient for the number of bits to be FEC coded. For example, rather than using a conventional algebraic coding algorithm for coding a few bits in a frame, a more efficient coding algorithm can be used that is tuned to efficiently handle the low bit rate of the high priority bits. One example is as Reed-Solomon. However, the invention is not limited in this regard and any other algorithms can be selected to enhance performance.

Although bit prioritization has been described above with respect to a pre-defined number of high and low priority bits, the various embodiments of the invention are not limited in this regard. Rather, in the various embodiments of the invention, the number of high and low priority bits can be pre-defined or determined dynamically based on different factors. Although such bit prioritization increases complexity of the system, this complexity is tempered by the increase in system performance.

In the various embodiments of the invention, the factors for determining bit prioritization include channel conditions, such as SNR, signal fading rate, and multipath conditions, to name a few. However the invention in not limited in this regard and any other type of channel conditions can be used. Furthermore, testing and analysis under particular applications can also be used to determine a fixed number and type of bits for which error protection is to be used.

Input parameters to dynamic bit prioritization processes, such as SNR and other channel conditions, can be estimated by measuring signal power in environment where noise levels are fixed. Although SNR is more difficult to measure in dynamic noise environments, as the noise is generally obscured by a stronger signal, most communication systems have idle periods in which the noise power can be estimated or alternatively the noise power can be estimated from the quality of the decision in the demodulator. However, the invention is not limited to computing SNR as described above and any other known methods for computing SNR can be used in the various embodiments of the invention.

In some cases it is not possible or desirable to perform bit prioritization. For example, in the case of data frames, redundancy is usually desirable for all bits in the frame. In another example, channel conditions may be so poor that redundancy for all bits is needed, regardless of the priority of the various bits. Therefore, alone or in combination with bit prioritization, an FEC coding scheme can be changed from a lower coding rate scheme, such as a Reed Solomon scheme, to a Turbo Code coding scheme with equivalent or better performance. Turbo code is a soft-decision code, with performance typically approaching the Shannon limit. As used herein with respect to a communications channel, the “Shannon limit” or “Shannon capacity”, is the theoretical maximum information transfer rate of the channel, for a particular noise level.

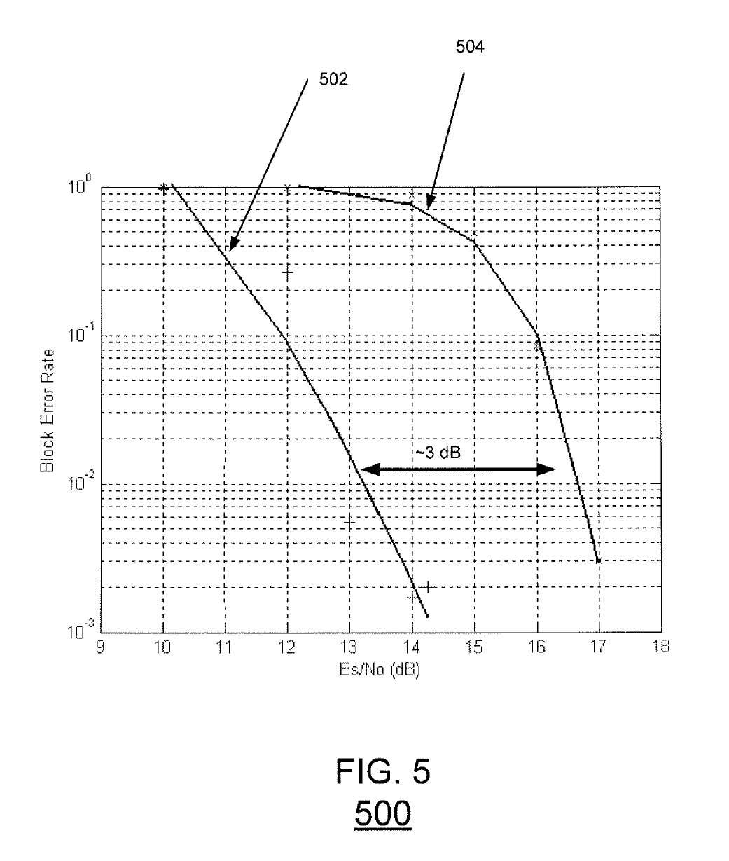

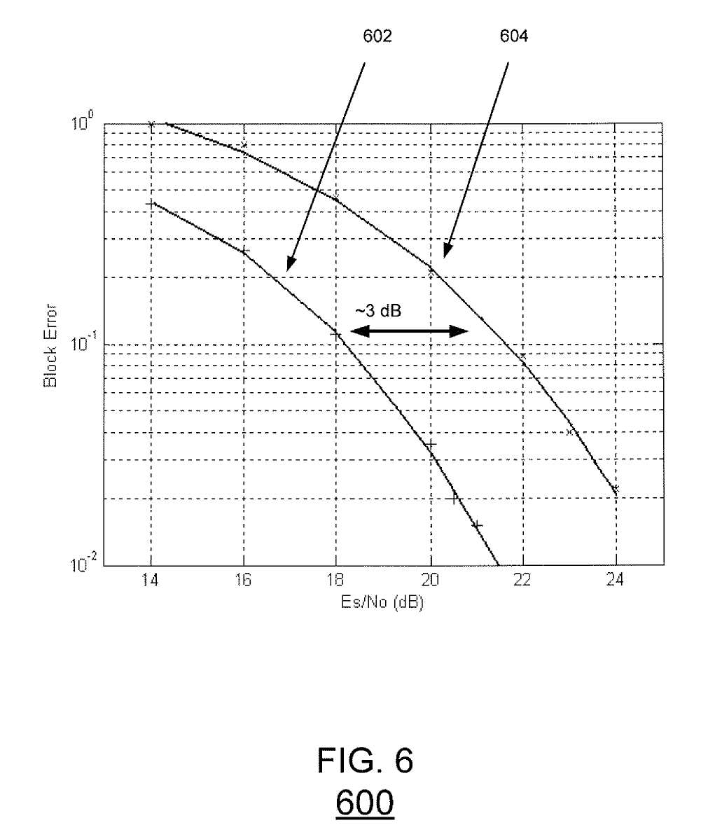

Although more computationally intensive than Reed Solomon codes, as an example, Turbo codes can provide better performance under the equivalent channel conditions. This improved efficiency can result in demodulator/FEC performance approximately 3 dB better in a Gaussian channel than with an equivalent Reed Solomon code. Turbo code also provides 3 dB gain in a fading/multipath channel as well. This is illustrated in FIGS. 5 and 6. FIG. 5 is a log plot 500 of block error rate versus Es/No (the energy per bit to noise power spectral density ratio) for Turbo codes (trend line 502 with data points marked by crosses “+”) and Reed-Solomon codes (trend line 504 with data points marked by x marks “x”) on a Gaussian channel. As shown in FIG. 5, the coding gain (i.e., the difference in Es/No for a particular block error rate) between 502 and 504 is approximately 3 dB. FIG. 6 is a log plot 600 of block error rate versus Es/No for Turbo codes (trend line 602 with data points marked by crosses “+”) and Reed-Solomon codes (trend line 604 with data points marked by x marks “x”) on a Fading channel. As shown in FIG. 6, the coding gain is also approximately 3 dB.

There are two classes of Turbo Codes: Block Turbo Codes (BTC) and Convolutional Turbo Codes (CTC). In general, BTC performance is better at high coding rates and is also less computationally complex than CTC. Accordingly, in some embodiments of the invention, BTC is preferably used to replace any Reed Solomon encoders and decoders used in a wireless communication system. However, the invention is not limited in this regard and any type of Turbo code can be used in the various embodiments of the invention.

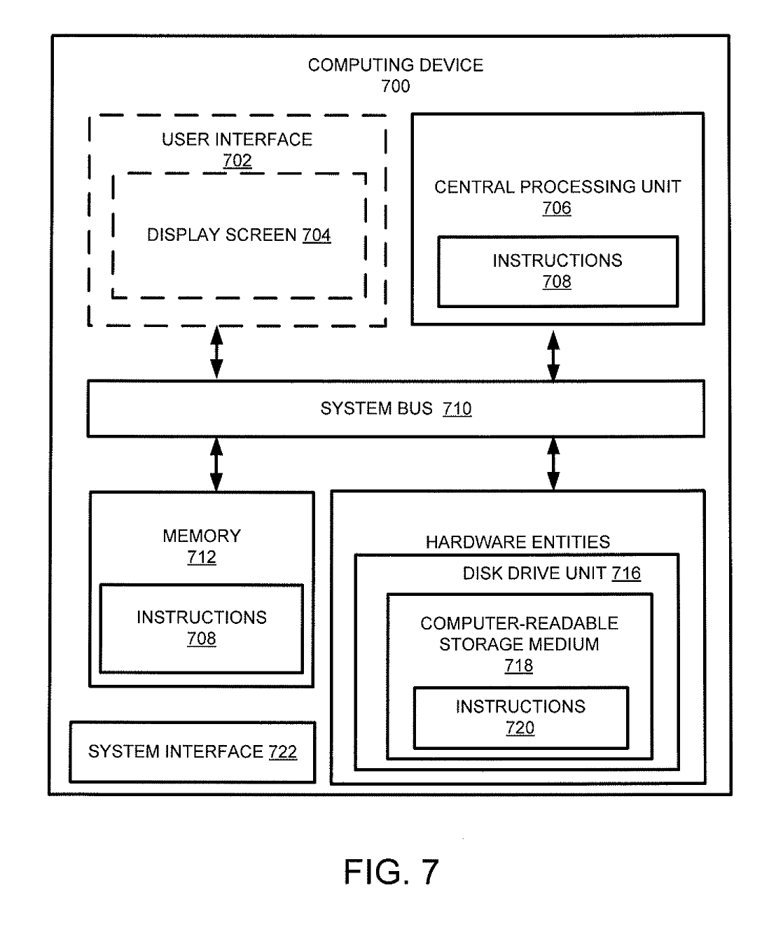

The various embodiments or components thereof, for example, the decoders or controllers therein, may be implemented as part of one or more computer systems. Referring now to FIG. 7, there is provided a block diagram of a computing device 700 which can be configured for performing one or more methods described above in accordance with an embodiment of the invention. Although various components are shown in FIG. 7, the computing device 700 may include more or less components than those shown in FIG. 7. However, the components shown are sufficient to disclose an illustrative embodiment of the invention. The hardware architecture of FIG. 7 represents only one embodiment of a representative computing device.

As shown in FIG. 7, computing device 700 includes a system interface 722, a Central Processing Unit (CPU) 706, a system bus 710, a memory 712 connected to and accessible by other portions of computing device 700 through system bus 710, and hardware entities 714 connected to system bus 710. At least some of the hardware entities 714 perform actions involving access to and use of memory 712, which may be any type of volatile or non-volatile memory devices. Such memory can include, for example, magnetic, opt cal, or semiconductor based memory devices. However the various embodiments of the invention are not limited in this regard.

In some embodiments, computing system can include a user interface 702. User interface 710 can be an internal or external component of computing device 700. User interface 702 can include input devices, output devices, and software routines configured to allow a user to interact with and control software applications installed on the computing device 700. Such input and output devices include, but are not limited to, a display screen 704, a speaker (not shown), a keypad (not shown), a directional pad (not shown), a directional knob (not shown), and a microphone (not shown). As such, user interface 702 can facilitate a user-software interaction for launching software development applications and other types of applications installed on the computing device 700.

System interface 722 allows the computing device 700 to communicate directly or indirectly with the other devices, such as an external user interface or other computing devices. Additionally, computing device can include hardware entities 714, such as microprocessors, application specific integrated circuits (ASICs), and other hardware. As shown in FIG. 7, the hardware entities 714 can also include a removable memory unit 716 comprising a computer-readable storage medium 718 on which is stored one or more sets of instructions 720 (e.g., software code) configured to implement one or more of the methodologies, procedures, or functions described herein. The instructions 720 can also reside, completely or at least partially, within the memory 712 and/or within the CPU 706 during execution thereof by the computing device 700. The memory 712 and the CPU 706 also can constitute machine-readable media.

While the computer-readable storage medium 718 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to solid-state memories (such as a memory card or other package that houses one or more read-only (non-volatile) memories, random access memories, or other re-writable (volatile) memories), magneto-optical or optical medium (such as a disk or tape). Accordingly, the disclosure is considered to include any one or more of a computer-readable storage medium or a distribution medium, as listed herein and to include recognized equivalents and successor media, in which the software implementations herein are stored.

System interface 722 can include a network interface unit configured to facilitate communications over a communications network with one or more external devices. Accordingly, a network interface unit can be provided for use with various communication protocols including the IP protocol. Network interface unit can include, but is not limited to, a transceiver, a transceiving device, and a network interface card (NIC).

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A wireless communications device, comprising:
a demodulator configured for computing a plurality of estimated bits for a modulated input signal representing a plurality of symbols associated with a frame, said plurality of estimated bits comprising estimated values for a plurality of frame bits and at least one forward error correction (FEC) error bit encoded into said plurality of symbols; and
at least one FEC decision decoder configured for receiving at least a first portion of said plurality of estimated bits and calculating values for a first portion of said plurality of frame bits associated with said first portion of said plurality of estimated bits,
wherein said plurality of estimated bits are computed based on a condition of a communication channel associated with said modulated input signal and a frequency deviation (L) associated with said demodulator.

2. The wireless communications device of claim 1, wherein said condition of said communications channel is signal to noise ratio (SNR).

3. The wireless communications device of claim 2, wherein said demodulator is further configured to compute said plurality of estimated bits based on a log-likelihood ratio (LLR) value for each of said plurality of symbols, and wherein said LLR value is given by:
LLR=SNR×L^{α}
where α is a weighting factor.

4. The wireless communications device of claim 3, wherein said weighting factor is pre-defined.

5. The wireless communications device of claim 3, wherein said weighting factor is adjusted dynamically.

6. The wireless communications device of claim 1, wherein said FEC decision decoder is further configured to operate using a Turbo code algorithm.

7. The wireless communications device of claim 1, wherein said FEC error bit is associated with a portion of said plurality of frame bits, and further comprising a bit prioritization element configured for directing said FEC error bit and said portion of said frame bits into said FEC decision decoder.

8. The wireless communications device of claim 7, where said bit prioritization element is further configured for directing a second portion of said plurality of frame bits to bypass said FEC decision decoder.

9. The wireless communications device of claim 1, wherein said modulated input signal comprises a continuous phase modulated signal.

10. A method for operating a wireless communications device in a wireless communications network, comprising:
demodulating a modulated input signal received over a communication channel, said modulated input signal comprising a plurality of symbols associated with a frame;
computing a plurality of estimated bits from said modulated input signal, said plurality of estimated bits comprising estimated values for a plurality of frame bits and at least one forward error correction (FEC) error bit encoded into said plurality of symbols; and
calculating values for at least a first portion of said plurality of frame bits associated with said first portion of said plurality of estimated bits,
wherein said plurality of estimated bits are computed based on a condition of said communication channel and a frequency deviation (L) associated with said demodulating.

11. The method of claim 10, wherein said condition of said communications channel is selected to be signal to noise ratio (SNR).

12. The method of claim 11, wherein said computing comprises determining said plurality of estimated bits based on a log-likelihood ratio (LLR) value for each of said plurality of symbols, and wherein said LLR value is given by:
LLR=SNR×L^{α}
where α is a weighting factor.

13. The method of claim 12, wherein said weighting factor is pre-defined.

14. The method of claim 12, wherein said weighting factor is adjusted dynamically.

15. The method of claim 10, wherein calculating is performed using a Turbo code algorithm.

16. The method of claim 10, wherein said FEC error bit is associated with a portion of said plurality of frame bits, and wherein said calculating further comprises directing said FEC error bit and said portion of said frame bits into said FEC decision decoder.

17. The method of claim 16, further comprising directing a second portion of said plurality of frame bits to bypass said FEC decision decoder.

18. A method of performing soft decision calculations in a multi-level continuous phase modulation (CPM) system, the method comprising:
determining phase and amplitude information for an input modulated signal; and
performing said soft decision calculations using the determined phase and amplitude information.

19. The method of claim 18, wherein said performing comprises computing a log-likelihood ratio (LLR) value, and wherein said LLR value is given by:
LLR=SNR×L^{α}
where SNR is said amplitude information, L is said phase information, and α is a weighting factor.

20. The method of claim 19, wherein said soft decisions calculations are performed using a block Turbo code algorithm.
